(19) United States
(12) Patent Application Publication
(10) Pub. No.: US 2017/0371444 A9
(43) Pub. Date: Dec. 28, 2017

(54) SELF-CAPACITANCE TOUCH DETECTION CIRCUIT

(71) Applicant: Shenzhen Goodix Technology Co., Ltd., Shenzhen (CN)

(72) Inventors: Kuohao CHAO, Shenzhen (CN); Fuchiang YANG, Shenzhen (CN); Mengta YANG, Shenzhen (CN)

(21) Appl. No.: 15/231,211

(22) Filed: Aug. 8, 2016

Related U.S. Application Data
(63) Continuation of application No. PCT/CN2014/088718, filed on Oct. 16, 2014.

(30) Foreign Application Priority Data
Jun. 6, 2014 (CN) 201410250172.4

(51) Int. Cl. G06F 3/044; G06F 3/041

(52) U.S. Cl. CPC G06F 3/044; G06F 3/0416

(57) ABSTRACT

A self-capacitance touch detection circuit includes a signal generator, a first amplifier, a cancellation signal generator and an analog-to-digital converter. The signal generator generates a driving signal and then the driving signal is divided into a first output branch and a second output branch, the first output branch being connected to the cancellation signal generator, a signal passing through an offset circuit being output to a first input terminal of the amplifier, and the second output branch being respectively connected to a touch panel and a second input terminal of the amplifier; the amplifier outputs a signal to the analog-to-digital converter; and the analog-to-digital converter converts the signal into a digital signal and sends the digital signal to a main controller.

### CROSS-REFERENCE TO RELATED APPLICATIONS

The present application is a continuation of international application No. PCT/CN2014/088718, filed on Oct. 16, 2014, which claims priority to Chinese Patent Application No. 201410250172.4, filed on Jun. 6, 2014, both of which are hereby incorporated by reference in their entireties.

### TECHNICAL FIELD

The present disclosure relates to the technical field of circuits, and in particular, relates to a self-capacitance touch detection circuit for use in a capacitive touch screen.

### BACKGROUND

Conventional capacitive touch screens or keys mainly employ self-capacitance detection of touch input and mutual-capacitance detection of touch input. With the self-capacitance detection technology, one terminal of a capacitor is grounded, and signals are sent and received from the other terminal of the capacitor for detecting variations of the capacitance, thereby identifying whether there is a touch input. Detecting variations of a single self-capacitance only needs one IO port, and thus fewer IO ports are required. In addition, such touch screens may be practiced and manufactured by using a single layer of conductive material, which greatly saves the manufacture cost of the screens. With the mutual-capacitance detection technology, signals are sent from one terminal of a capacitor and are received from the other terminal of the capacitor thus to detect variations of the capacitance, thereby identifying whether there is a touch input. Therefore, detecting variations of a single mutual-capacitance needs two IO ports, and thus relatively more IO ports are required. In addition, such touch screens may be practiced and manufactured by using two layers of conductive materials, which relatively increases the manufacture cost of the screens.

There are a plurality of detection methods available in the conventional self-capacitance detection technology. Some detection methods are based on the relaxation oscillation principle, and convert the capacitance into a frequency or periodic signal for measurement. Some detection methods are based on charging and discharging of resistors and capacitors, and measure the capacitance by performing single-slope or double-slope integral counting. Still some detection methods measure the capacitance by adjusting the charging and discharging currents of the capacitor based on successive approximation. These self-capacitance detection methods may have a common defect, that is, weak capabilities resistant to the environmental interference. Particularly with respect to touch screens equipped on mobile phones, interference comes from both LCDs and mobile phone radio frequency signals. In the conventional self-capacitance detection methods, the signal-to-noise ratio of the touch signals detected is not very high, generally below 30:1. Therefore the resolution of the touch screen may be low, or the touch detection may be simply subjected to mis-actions or the like.

### SUMMARY

The present disclosure provides a self-capacitance touch detection circuit. With a cancellation signal generator being configured, the amplification factor of the amplifier can be increased and the anti-interference capability of the detection circuit can be improved.

An embodiment of the present disclosure may be implemented as a self-capacitance touch detection circuit including a signal generator, a first amplifier, a cancellation signal generator and an analog-to-digital converter, wherein the signal generator generates a driving signal and then the driving signal is divided into a first output branch and a second output branch, the first output branch being connected to the cancellation signal generator, a signal passing through an offset circuit being output to a first input terminal of the amplifier, and the second output branch being respectively connected to a touch panel and a second input terminal of the amplifier; the amplifier outputs a signal to the analog-to-digital converter; and the analog-to-digital converter converts the signal into a digital signal and sends the digital signal to a main controller.

In one embodiment, the signal generator includes a sinusoidal wave generator and a digital-to-analog converter, wherein the sinusoidal wave generator generates a sinusoidal wave signal, and the digital-to-analog converter converts the sinusoidal wave signal into an analog signal.

In one embodiment, the cancellation signal generator includes a first resistor, a second resistor and a first capacitor; wherein one terminal of the first resistor is connected to the first output branch and the other terminal of the first resistor is connected to the first input terminal of the amplifier, one terminal of the first capacitor is grounded and the other terminal of the first capacitor is connected to one terminal of the second resistor, and the other terminal of the second resistor is connected to the first input terminal of the amplifier.

Preferably, the first resistor and the second resistor are variable resistors, and the first capacitor is a variable capacitor.

In one embodiment, a second amplifier is further connected between the cancellation signal generator and the first input terminal of the amplifier.

In one embodiment, the self-capacitance touch detection circuit further includes a filter, wherein the filter is connected between the first amplifier and the analog-to-digital converter.

In one embodiment, the self-capacitance touch detection circuit further includes a third resistor, wherein the third resistor is connected between the signal generator and the second input terminal of the amplifier.

Preferably, the third resistor is a variable resistor.

Preferably, the amplifier is a programmable gain amplifier.

Preferably, the filter is an anti-aliasing filter.

In the self-capacitance touch detection circuit according to the present disclosure, with a cancellation signal generator being configured between the signal generator and the amplifier, the amplification factor of the amplifier is increased and the anti-interference capability of the detection circuit is improved.

### BRIEF DESCRIPTION OF THE DRAWINGS

FIG. 1 is a block diagram illustrating principles of a self-capacitance touch detection circuit according to one embodiment of the present disclosure;

FIG. 2 is a block diagram illustrating principles of a self-capacitance touch detection circuit according to another embodiment of the present disclosure;

FIG. 3 is a block diagram illustrating principles of an equivalent circuit of the self-capacitance touch detection circuit connected to a touch panel shown in FIG. 1; and

FIG. 4 is a block diagram illustrating principles of a cancellation signal generator according to one embodiment of the present disclosure.

### DETAILED DESCRIPTION

To make the objective, technical solution, and advantages of the present disclosure clearer, the following section describes the technical solutions of the present disclosure in combination with the accompanying drawings and embodiments. It should be understood that the embodiments described here are only exemplary ones for illustrating the present disclosure, and are not intended to limit the present disclosure.

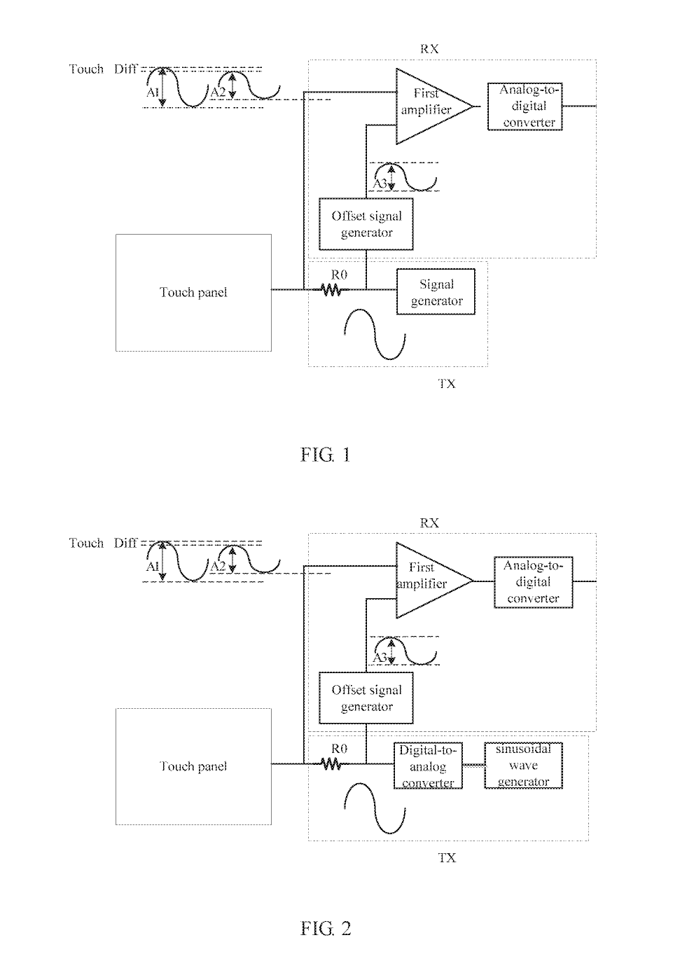

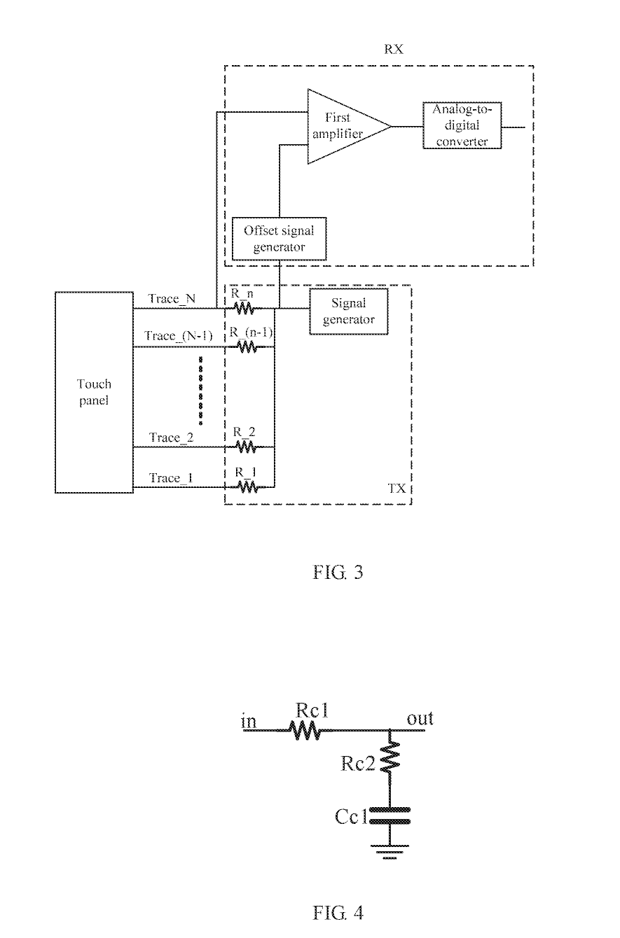

As illustrated in FIG. 1, a self-capacitance touch detection circuit includes a signal generator, an amplifier, a cancellation signal generator, a filter and an analog-to-digital converter; wherein the signal generator generates a driving signal and then the driving signal is divided into a first output branch and a second output branch. The first output branch is connected to the cancellation signal generator, a signal passing through the cancellation signal generator being output to a first input terminal of the amplifier. The second output branch is respectively connected to a touch panel and a second input terminal of the amplifier; the amplifier outputs a signal to the analog-to-digital converter. The analog-to-digital converter converts the signal into a digital signal and sends the digital signal to a main controller. Preferably, in this embodiment, the amplifier is a programmable gain amplifier (PGA). The self-capacitance touch detection circuit may further include a filter, the filter is connected between the first amplifier and the analog-to-digital converter and the filter is an anti-aliasing filter. Preferably, the first input terminal is an inverting input terminal, and the second input terminal is a non-inverting input terminal.

As illustrated in FIG. 2, in one embodiment of the present disclosure, the signal generator includes a sinusoidal wave generator and a digital-to-analog converter, wherein the sinusoidal wave generator generates a sinusoidal wave signal, and the digital-to-analog converter converts the sinusoidal wave signal into an analog signal. A driving end TX outputs a sinusoidal wave having a defined frequency, and the sinusoidal wave is sent to a sensing end RX after being attenuation by a touch panel and is meanwhile attenuated after passing through the cancellation signal generator (assume that an amplitude attenuation is A3). In the case that no cancellation signal generator exists, a digital circuit may parse out that the amplitude is A1, after being touched by a finger, the amplitude becomes A2, and a touch difference=A1-A2. In the case that a cancellation signal generator is included, the digital circuit may parse out that the amplitude is A1-A3, after being touched by a finger, the amplitude becomes A2-A3, and a touch difference=(A1-A3)-(A2-A3)=A1-A2. With respect to an amplifier, the amplitude of an output signal is generally constant, and a subtraction is performed between the signal at the reference terminal and the signal at the input terminal, A1-A3. The amplitude of the input signal of the analog-to-digital converter can be greatly reduced from the original AlxPGA_gain to (A1-A3)xPGA_gain, which is equivalent to PGA gain or Al may be increased. The requirement of noise imposed by the circuit after the amplifier can be reduced. In the meantime, the flicker noise of the digital-to-analog converter may also be greatly eliminated, thereby improving the anti-interference capability of the detection circuit.

As illustrated in FIG. 4, in one embodiment of the present disclosure, the cancellation signal generator includes a first resistor Rc1, a second resistor Rc2 and a first capacitor Cc1; wherein one terminal of the first resistor Rc1 is connected to the first output branch, and the other terminal of the first resistor Rc1 is connected to the first input terminal of the amplifier. One terminal of the first capacitor Cc1 is grounded, and the other terminal of the first capacitor Cc1 is connected to one terminal of the second resistor Rc2; the other terminal of the second resistor Rc2 is connected to the first input terminal of the amplifier. Preferably, to accommodate different application scenarios, the first resistor Rc1 and the second resistor Rc2 may both be variable resistors, the resistances of which can be selected as required. Similarly, the first capacitor Cc1 is a variable capacitor, the capacitance of which can be selected as required.

Further, in one embodiment of the present disclosure, the self-capacitance touch detection circuit further includes a third resistor Rc3, wherein the third resistor is connected between the signal generator and the second input terminal of the amplifier. Preferably, the third resistor is a variable resistance, the resistance of which is selected as required.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

### INDUSTRIAL APPLICABILITY

According to the self-capacitance touch detection circuits of the present disclosure, the gain of the amplifier can be enhanced by adding a cancellation signal generator between the signal generator and the amplifier, therefore the anti-interference ability of the detection circuit is improved.

What is claimed is:

1. A self-capacitance touch detection circuit, comprising a signal generator, a first amplifier, a cancellation signal generator and an analog-to-digital converter,
wherein the signal generator is configured to generate a driving signal and then the driving signal is divided into a first output branch and a second output branch, the first output branch is connected to the cancellation signal generator, a signal passing through the cancellation signal generator is output to a first input terminal of the amplifier, and the second output branch is respectively connected to a touch panel and a second input terminal of the amplifier;
the amplifier is configured to output a signal to the analog-to-digital converter; and the analog-to-digital converter is configured to convert the signal output by the amplifier into a digital signal and send the digital signal to a main controller.

2. The self-capacitance touch detection circuit according to claim 1, wherein the signal generator comprises a sinusoidal wave generator and a digital-to-analog converter, wherein the sinusoidal wave generator is configured to generate a sinusoidal wave signal, and the digital-to-analog converter is configured to convert the sinusoidal wave signal into an analog signal.

3. The self-capacitance touch detection circuit according to claim 1, wherein the cancellation signal generator comprises a first resistor, a second resistor and a first capacitor, wherein one terminal of the first resistor is connected to the first output branch and the other terminal of the first resistor is connected to the first input terminal of the amplifier, one terminal of the first capacitor is grounded and the other terminal of the first capacitor is connected to one terminal of the second resistor, and the other terminal of the second resistor is connected to the first input terminal of the amplifier.

4. The self-capacitance touch detection circuit according to claim 3, wherein the first resistor and the second resistor are variable resistors, and the first capacitor is a variable capacitor.

5. The self-capacitance touch detection circuit according to claim 1, wherein a second amplifier is further connected between the cancellation signal generator and the first input terminal of the amplifier.

6. The self-capacitance touch detection circuit according to claim 1, further comprising a filter, wherein the filter is connected between the first amplifier and the analog-to-digital converter.

7. The self-capacitance touch detection circuit according to claim 6, wherein the filter is an anti-aliasing filter.

8. The self-capacitance touch detection circuit according to claim 1, further comprising a third resistor, wherein the third resistor is connected between the signal generator and the second input terminal of the amplifier.

9. The self-capacitance touch detection circuit according to claim 8, wherein the third resistor is a variable resistor.

10. The self-capacitance touch detection circuit according to claim 1, wherein the amplifier is a programmable gain amplifier.
